(19) United States
(12) Patent Application Publication
(10) Pub. No.: US 2022/0179069 A1
(43) Pub. Date: Jun. 9, 2022

(54) SYSTEM AND METHOD FOR THE DETECTION OF OBJECTS CONCEALED BENEATH THE CLOTHING OF A PERSON

(71) Applicants: SAN JORGE TECNOLÓGICAS SL, Madrid (ES); UNIVERSIDAD DE ALCALÁ, Alcala de Henares (ES)

(72) Inventors: Javier CORELLA ROMERO, Madrid (ES); José Luis PÉREZ DÍAZ, Alcala de Henares (ES)

(21) Appl. No.: 17/587,511

(22) Filed: Jan. 28, 2022

Related U.S. Application Data
(63) Continuation of application No. PCT/ES2020/070420, filed on Jun. 30, 2020.

(30) Foreign Application Priority Data
Jul. 30, 2019 (ES) P201930704

(51) Int. Cl. G01S 15/88; G01N 29/04; G01N 29/12

(52) U.S. Cl. CPC G01S 15/88; G01N 2291/044; G01N 29/12; G01N 29/043

(57) ABSTRACT

A system and method for the detection of objects concealed beneath the clothing of a person that includes at least one acoustic wave emitter directed toward the person, where the waves are non-stationary low frequency near-field acoustic waves. At least one acoustic wave detector is oriented towards the person in order to receive any acoustic waves reemitted by the person in response to interaction with the non-stationary low frequency near-field acoustic waves, in such a wat that analysis of the reemitted acoustic waves detected by at least one detector enables the determination of whether the person is carrying any object concealed beneath their clothing.

### CROSS-REFERENCE TO RELATED APPLICATIONS

This application relates to and claims the benefit and priority to International Application No PCT/ES2020/070420, filed Jun. 30, 2020, which claims the benefit and priority to Spanish Application No. P201930704, filed Jul. 30, 2019.

### FIELD

The present invention belongs in general to the field of security, and more specifically to the detection of illegal or illicit goods carried by a person.

A first aspect of the present invention is a system designed for detecting objects concealed under the clothes of a person with a high reliability and without the need of subjecting the person to potentially harming radiations.

A second aspect of the present invention is a method to detect hidden objects suitable for execution by the system disclosed.

### BACKGROUND

Currently, to prevent the risk of terrorist attacks in places where numerous people access, for instance, airports, sports events, musicals, religious and festive events, etc., as well as to limit the illegal traffic of substances or goods across borders and customs, such as drugs, currency, tobacco, etc., it is necessary to control the items that people carry. This control is performed by using devices designed to detect objects that are potentially hazardous, forbidden or restricted for, if needed, banning entrance to the persons carrying them.

Since, in many occasions, it is necessary to control a large number of people in a very short time, especially in the transport sector, the detection process must be fast. Additionally, it is also necessary to be respectful with travelers. This implies limiting as much as possible, the radiations they are exposed to as well as respecting their intimacy avoiding the generation of intimate images.

Presently, the main technique used for the detection of concealed items is the conventional manual pad down. This technique is highly invasive, slow, unpleasant, poorly respectful with intimacy of inspected persons and dangerous for the inspector (for instance, in the case of detection of explosive belts). It additionally presents an intensive need of personnel of both sexes to avoid the need of performing pad downs to persons of the other sex. Another drawback of this technique is its low effectiveness on body parts that are especially sensitive or critical, such as genitals.

Other technique widely used are the millimeter wave scanners that are based on the emission of electromagnetic waves with wavelengths located in the electromagnetic spectrum region corresponding to microwaves. This kind of devices are described, for instance, at the Appleby, R (15 Feb. 2004). “Passive millimetre-wave imaging and how it differs from terahertz imaging”. Philosophical Transactions o of the Royal Society. A: Mathematical, Physical and Engineering Sciences. 362 (1815): 379-393.].

However, this technology presents serious privacy problems because it shows an image of the full body of the scanned person. Moreover, there is still discussion about the potential adverse effects that the use of this technology may have on health.

Another technique is based on the emission of an X-ray beam that reaches the surface of the body of the scanned person. Rays are dispersed or reflected and they reach a detector. Thus, by computer processing, an image of the person is formed, making possible to detect concealed items under the clothes. This kind of technique is described, for instance, in the patent document U.S. Pat. No. 5,181,234 by Steven W. Smith entitled “X-ray Backscatter Detection System”

This technology presents essentially the same drawbacks of the previous one regarding privacy. With respect to consequences on health, drawbacks are higher for this last technique as it uses ionizing radiation. Despite it being used with very low doses, the effects on health of these radiations are not clear yet.

It is also known, although in a completely different context, the use of acoustic ultrasonic waves for diagnosis and formation of images in the field of medicine (see, for instance, U.S. Pat. No. 3,688,564) and for inspecting defects and irregularities (see, for example, the documents of Canadian Patent No. 1,173,146 or U.S. Publication No. 20060201253). These are high frequency ultrasonic waves in far-field and stationary regime that reflect on the object to analyze and whose reflect is received and analyzed to obtain information about its shape. However, these ultrasonic high-frequency waves are easily absorbed and reflected in material discontinuities and interfaces (with a jump of acoustic impedance). For this reason, a light cloth is enough to reflect or completely absorb the wave. As they do not penetrate through the clothes, it is evident that these waves are not useful to detect anything beneath them.

Moreover, even considering the emission of low frequency acoustic waves able to travel through clothes, they would only be able to detect objects sized at least the order of magnitude of their wavelength, and would not be operative as these wavelengths would be of the order of magnitude of one meter.

In conclusion, there is still a need in this field for improved devices for detection of concealed items under the clothes solving the abovementioned drawbacks.

### SUMMARY

Disclosed are methods and systems to detect objects hidden beneath the clothes by the emission of acoustic low frequency waves in near field and non-stationary regime.

When a non-stationary (transient) acoustic wave excites a mechanical element essentially composed by masses, stiffness and dumpers (hysteresis or viscosities) that forms its acoustic-mechanical impedance, the response of such mechanical element depends on the values of those parameters. That is, in transient regime, the differences in responses are amplified according to their vibration and oscillation modes. It occurs even if the wavelength of the acoustic wave has a significantly bigger size than the biggest of the excited elements.

Thus, when a non-stationary acoustic wave interacts with a human body that has attached in any way an object of determined mass and stiffness, an interaction occurs exciting the mechanical elements (Human body and object), and they respond in a different way if the stiffness and/or masses are different. The inventors of the present invention discovered that, analyzing the acoustic waves reemitted after detecting them by using one or a plurality of microphones distributed close to the body of the person, it is possible to determine if the person has any foreign object attached to their body. More precisely, this is achieved because the acoustic waves received from a person carrying an object attached to the body present detectable differences from the acoustic waves received if the person does not carry anything attached to their body.

In this document, the term “low frequency acoustic wave” refers to a mechanical wave transmitted in the air whose frequency is lower to approximately 200 Hz either audible or not. A particular example of low frequency acoustic wave is infrasound, whose frequency is lower than the human hearing threshold that is approximately 20 Hz.

In this document, the term “non-stationary regime” referred to an acoustic wave, refers to a mechanical wave (sound or infrasound) whose characteristics of amplitude, and frequency vary in a time comparable with its characteristic period (or the inverse of their main frequency). In this way, a frequency is held only for a few cycles at the most.

In this document, the term “near-field” referred to an acoustic wave, refers to the area of the sound field where sound pressure and velocity of particles are not in phase. This region is limited to a distance, measured from the sound source, of the order of magnitude of the wavelength of the emitted sound d. (See, for instance, page 27 of “Fundamentals of acoustics” of Professor Colin H. Hansen https://www.who.int/occupational_health/publications/noise1.pdf that cites in turn standard ISO 12001.

A first aspect of the present invention covers a system for the detection of concealed items under the clothes of a person that comprises essentially an acoustic emitter and an acoustic detector. Each of these elements is described in more detail below:

Emitter

At least, one emitter of acoustic waves that faces to the person, and where the waves are low frequency acoustic waves in non-stationary and near field regime.

Although in a basic system configuration, a single emitter is used, it is possible to have several emitters facing to the person from different directions. This option, as it excites better different parts of the body of the person, it increases the number of sound waves received as a response, and thus, it enables an increase in the precision of the system.

The emitter of acoustic waves can be a speaker or a conduit that connects the speaker with the enclosure, it must be placed at a distance from the person to be inspected to ensure a determined minimum intensity. This distance can be, for instance, between 50 and 700 mm.

Regarding frequency of the emitted sound waves, it can be any, provided it excites the skin of the inspected person in a way that, in response, it reemits acoustic waves that could be received by the detector that is described below. For instance, in general is sufficient if the frequency is lower than a few hundred hertz.

However, the inventors discovered that the invention system is particularly effective when the frequency of acoustic waves emitted meets with the skin resonance of the inspected person. The resonance frequency of the skin of a person could be between approximately 2 and 200 Hz. Hence, according to a particularly preferred embodiment of the invention, the low frequency acoustic waves in a non-stationary regime have frequencies between 2 and 200 Hz.

Detector

It is, at least, one detector of acoustic waves also facing to the person to receive some acoustic waves reemitted by the person in response to the interaction with the low frequency waves in non-stationary and near field regime.

Although in a basic system configuration of the system of the invention, a single detector is used, it is possible to have several detectors facing to the person from different directions with the purpose of receiving the waves reemitted by different parts of the skin of the human body. Indeed, different parts of the skin of the human body resonate at different resonance frequencies emitting acoustic waves in different directions. Placing dedicated detectors for several of these reemitted acoustic waves, increases the amount of information obtained as response and therefore, increases the precision of the system.

Additionally, the detector of acoustic waves, that could be a microphone of adequate characteristics, should be placed at a distance from the person to which the reemitted acoustic waves reach in the clearest possible way. For instance, according to a particularly preferred embodiment of the invention, at least, an acoustic wave detector is placed at a distance between 0.1 and 2 m from the person

In this way, after the emission of acoustic waves towards the person and the detection of the corresponding acoustic waves reemitted by the person, an analysis of such reemitted acoustic waves makes it possible to determine if the person is concealing an item beneath the clothes.

Generally, the reemitted sound intensity is lower if there is an object or a material on the skin. That is, if no object is located on the skin, the skin will resonate and remit acoustic waves more intensively in comparison to skin on which an object resides. The clothing does not usually affect the formation of these waves. Therefore, if the received acoustic waves are compared with some reference acoustic waves corresponding to a person that does not carry any attached object, it is possible to detect differences that show the presence or absence of such object. To do this comparison, it is possible to use different mathematical parameters such as the Fourier Transform, phase shift, phase shift in the resonance peaks, signal delay or just amplitude. In principle, the analysis step can be done using any adequate mean for processing, as for example, a microcontroller, a microprocessor, a computer, an ASIC, a DSP, a FPGA, or others. Also, the means for processing could be placed in a remote location to which the signals are sent to by any known mean, as for instance, Bluetooth, Wi-Fi, internet, telephone network (GSM, UMTS, or others), etc.

In any case, in a particularly preferred embodiment of the invention, the system of the invention comprises as well, a mean of processing connected to the detector for receiving and analyzing the reemitted waves detected by the detector and thus determine if the person is carrying any item beneath the clothes.

A second aspect of the present invention is devoted to a method for the detection of concealed items beneath the clothes of a person that comprises essentially the following steps:

1) Emit, by at least, one emitter facing to the person, low frequency acoustic waves in a non-stationary regime and near field.

In principle, as it was described previously in this document, the frequency of the emitted acoustic waves will be between 2 Hz and 200 Hz. However, as the frequencies present slight variations, the inventors discovered that the precision of the inspection is improved if a sequence or a progressive sweep of frequencies is used. This sweep may be comprised, for instance between the 2 and 200 Hz, enabling in this way the detection of resonances independently of the body shape of the person and the detection of items with different masses, densities or mechanical constitutions.

In a more preferred embodiment of the invention, the interrogation sequence, uses a sweep of 460 cycles of frequencies between 30 Hz and 110 Hz in approximately 6 seconds so that each cycle has a frequency of 0.21 Hz higher than the previous. This permits that the different parts of the body (specially the skin at different areas) respond in a different manner to the different frequencies in the sweep, doing it so, in a certain moment of the sequence and in different ways if an object is attached or not. Above and below these frequencies, no relevant responses were found.

On the other hand, according to the experience of the inventors, the first reaction of the speakers, usually vary unpredictably and depends on its initial status. That is why in another preferable embodiment of the present invention, and in order to prevent the uncertainty at the start, a first tone with a fixed frequency is emitted with synchronization purposes. This fixed tone is sustained during one or a few cycles, preferably two cycles, before emitting the sequence of the frequency sweep. In this way, it is possible to synchronize unequivocally, the sound signals emitted, improving the precision of the system.

2) Receive, by using at least one receptor facing to the person, some acoustic waves reemitted by the person in response to the low frequency sound waves in a non-stationary regime and near field.

In effect, as it was described above in this document, the receptor receives the acoustic sound waves reemitted by the different parts of the body of the person excited by the acoustic waves emitted by the emitter.

3) Analyze, by any means for processing, the acoustic waves reemitted to determine if the person is carrying any object concealed beneath the clothes.

The means for processing receives from the receptor the acoustic waves reemitted by the body of the person. As it was mentioned above, the communication can be wireless and the means for processing can be placed in a remote location in relation with the rest of the system, although preferably, the means for processing is connected to the receptor.

As it was mentioned above in this document, an object attached to the body has a particular mass and presents a stiffness in its joint with the human body. This causes new vibration modes to appear and, additionally, modifies the response of the body against the sound excitation when it is interposed in the interaction of the sound wave with the skin of the body of the person. Thus, there appear differences between the reemitted signals from a person without any attached object and the signals reemitted by a person with an attached object.

Also, the room where the measurements take place presents acoustic modes that depend on its geometry. On the other hand, as the sound propagation speed in the air depends on the temperature and even humidity, those frequencies vary with weather conditions. In view of what, a measure taken in absence of person can be used as reference with the purpose of avoiding all this variability and improving the sensitivity of the device.

Hence, in a particularly preferred embodiment, the step of analyzing the reemitted acoustic waves to determine if the person is carrying any item hidden under the clothes comprises to compare the reemitted acoustic waves with a reference signal corresponding to the acoustic waves reemitted by a person without any concealed objects and/or a reference signal received in absence of person. This comparison can be done, for instance, using one or several of the following parameters: Fourier Transform, phase shift, phase shift in the resonance peaks, signal delay or just amplitude.

### BRIEF DESCRIPTION OF FIGURES

FIG. 1 shows a schematic view of a system for the inspection of a person.

FIG. 2 shows three response signals corresponding respectively, to the absence of person, person without attached object and person with attached object.

### DETAILED DESCRIPTION OF EXAMPLES

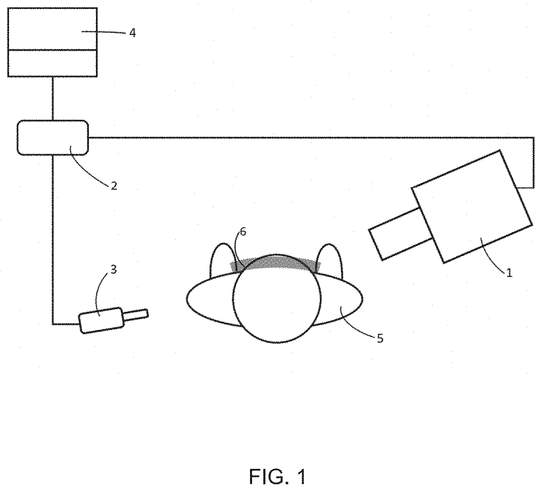

FIG. 1 shows an example of configuration of a system according to the present invention where the parts that conform it are shown. The system of this example comprises an emitter 1, in this case a PreSonus Temblor T10, and a detector 3, in this case, a Beyerdynamic MM1. The emitter 1 is pointed towards the person 5 and placed at approximately 1 meter from the person. On the opposite side of the person according to the direction of the emitter 1 it is the detector 3. The detector 3 is also oriented towards the person 5 and placed at 1 meter from the person. The emitter 1 and the detector 3 are both connected to a means for processing 4, in this case a PC with a sound interface 2 model Focusrite Scarlett 2i2.

Now, it is briefly described the use procedure of the described system. First, a first measurement is done in the absence of a person that will be used as reference (absent). Then, a second measurement is done with a person not carrying any object 6 attached (negative). Lastly, a third measurement is done with a person 5 that in this case carries an object 6 attached to the body (positive).

Each measurement includes the emission from the emitter 1 of low frequency acoustic waves in non-stationary and near field regime according to a sweep of frequencies that varies between 2 to 200 Hz. At the beginning, a fixed frequency tone is maintained for a few cycles to allow an appropriate synchronization. Then, the detector 3 receives the acoustic waves reemitted by the person 5, with or without attached object 6, and from the room wherein it is. These received acoustic waves are transmitted to the means of processing 4 to be analyzed.

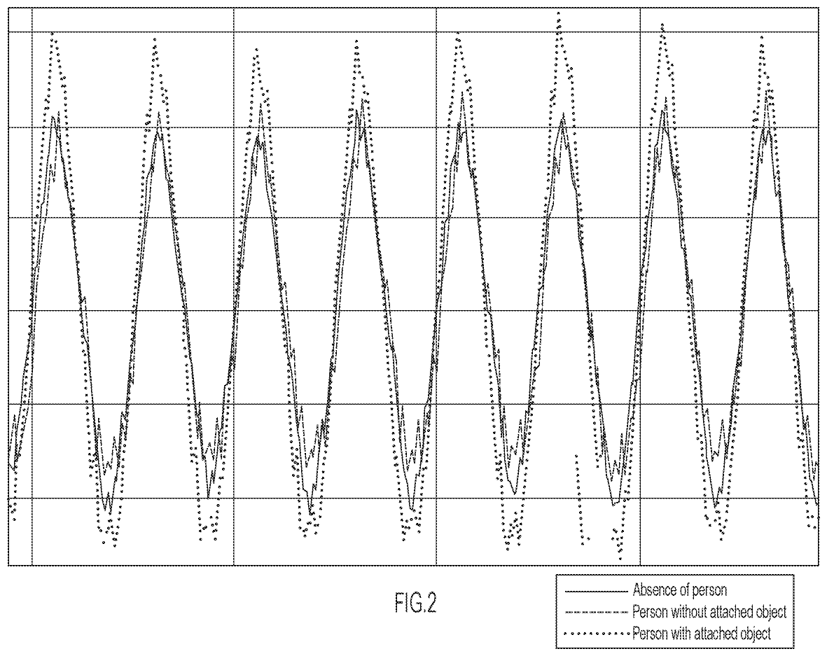

FIG. 2 shows the obtained results. It can be seen how in the case of a negative, the received signal presents, in a particular interval, a higher amplitude than of a positive or an absence, as well as a different profile. This enables the distinction of some signals from others manually, by a well-trained technician or automatically by an artificial intelligence, also well-trained. Thus, the system can be trained for automatic detection by using artificial intelligence algorithms that could be for instance the ones included in the package Classification Learner for MATLAB.

The research works associated with this disclosure was funded by H2020 program of the European Union under contract number 700399.

What is claimed is:

1. A system for the detection of objects concealed beneath clothing worn by a person, the system comprising:
a first emitter configured to emit towards the person in a first direction low frequency acoustic waves in near field and non-stationary regime;
a first detector of acoustic waves directed towards the person in a second direction, the first detector configured to receive first acoustic waves reemitted by the person in response to the interaction with the low frequency acoustic waves in near field and non-stationary regime; and
a processor configured to communicate with the first detector and configured to analyze the reemitted first acoustic waves detected by the first detector to determine if the person carries objects concealed beneath the clothing worn by the person.

2. The system according to claim 1, where the low frequency acoustic waves in near field and non-stationary regime have a frequency between 2 Hz and 200 Hz.

3. The system according to claim 1, where the first emitter is at a distance between 50 millimeters and 700 millimeters away from the person.

4. The system according to claim 2, where the first emitter is at a distance between 50 millimeters and 700 millimeters away from the person.

5. The system according to claim 1, where the first detector is at a distance between 0.1 meters and 2 meters from the person.

6. The system according to claim 3, where the first detector is at a distance between 0.1 meters and 2 meters from the person.

7. The system according to claim 4, where the first detector is placed at a distance between 0.1 meters and 2 meters from the person.

8. The system according to claim 1, further comprising a second emitter that is configured to emit low frequency acoustic waves in near field and non-stationary regime towards the person in a third direction different than the first direction.

9. The system according to claim 1, further comprising a second detector directed towards the person in a third direction different than the second direction, the second detector configured to receive second acoustic waves reemitted by the person in response to the interaction with the low frequency acoustic waves in near field and non-stationary regime emitted by the first detector, the second acoustic waves remitted being different than the first acoustic waves remitted.

10. The system according to claim 9, wherein the processor is configured to communicate with the first detector and the second detector and to analyze the reemitted first acoustic waves detected by the first detector and the remitted second acoustic waves detected by the second detector to determine if the person carries objects concealed beneath the clothing worn by the person.

11. A method for the detection of objects concealed beneath clothing of a person, the method comprising:
emitting from a first emitter low frequency acoustic waves in near field and non-stationary regime towards the person in a first direction;
receiving in a first detector first acoustic waves reemitted by the person in response to the interaction with the low frequency acoustic waves in near field and non-stationary regime, the first detector directed towards the person in a second direction: and
analyzing the reemitted first acoustic waves detected by the first detector to determine if the person carries objects concealed beneath the clothing worn by the person.

12. The method according to claim 11, where the low frequency acoustic waves in near filed and non-stationary regime comprise a frequency between 2 Hz and 200 Hz.

13. The method according to claim 11, wherein prior to emitting from the first emitter low frequency acoustic waves in near field and non-stationary regime towards the person, the first emitter emits a first tone of fixed frequency for synchronization with the first detector.

14. The method according to claim 13, where the first tone persists at least two cycles of the fixed frequency.

15. The method according to claim 11, wherein analyzing the reemitted first acoustic waves detected by the first detector to determine if the person carries objects concealed beneath the clothing worn by the person comprises comparing the reemitted first acoustic waves with a reference signal corresponding to acoustic waves reemitted by the person without any hidden object and/or a reference signal in absence of the person.

16. The method according to claim 11, where the first emitter is placed at a distance between 50 millimeters and 700 millimeters away from the person.

17. The method according to claim 12, where the first emitter is placed at a distance between 50 millimeters and 700 millimeters away from the person.

18. The method according to claim 11, where the first detector is placed at a distance between 0.1 meters and 2 meters from the person.

19. The method according to claim 16, where the first detector is placed at a distance between 0.1 meters and 2 meters from the person.

20. The method according to claim 17, where the first detector is placed at a distance between 0.1 meters and 2 meters from the person.

21. The method according to claim 11, further comprising emitting from a second emitter low frequency acoustic waves in near field and non-stationary regime towards the person in a third direction different than the first direction.

22. The method according to claim 11, further comprising a second detector directed towards the person in a third direction different than the second direction the second detector configured to receive second acoustic waves reemitted by the person in response to the interaction with the low frequency acoustic waves in near field and non-stationary regime emitted by the first detector, the second acoustic waves remitted being different than the first acoustic waves remitted.

23. The system according to claim 22, further comprising analyzing the reemitted second acoustic waves detected by the second detector to determine if the person carries objects concealed beneath the clothing worn by the person.
